(19) United States
(12) Patent Application Publication
(10) Pub. No.: US 2007/0136815 A1
(43) Pub. Date: Jun. 14, 2007

(54) CONTENT DATA REPRODUCING SYSTEM, CONTENT DATA REPRODUCING PROGRAM, AND REPRODUCING APPARATUS

(75) Inventors: Akihiro KASAHARA, Sanbu-gun (JP); Akira Miura, Sagamihara-shi (JP); Hiroshi Suu, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/550,089

(22) Filed: Oct. 17, 2006

(30) Foreign Application Priority Data
Oct. 21, 2005 (JP) 2005-307596

(51) Int. Cl. H04N 7/16

(52) U.S. Cl. 726/26

(57) ABSTRACT

There is provided a content data reproducing system that allows, in a user terminal adapted to be able to read a recording medium storing a content data encrypted with a predetermined encrypted key data, the content data to be reproduced after a CM data is reproduced. The system includes a CM data transmission portion that transmits the CM data to the user terminal in response to a request from the user terminal. When the sensing portion senses that the reproducing of the CM data has been completed in the user terminal, a permission portion permits the user terminal to use the encrypted key data to decrypt and reproducing the content data.

### CROSS REFERENCE TO RELATED APPLICATIONS

This application is based on and claims the benefit of priority from prior Japanese Patent Application No. 2005-307596, filed on Oct. 21, 2005, the entire contents of which are incorporated herein by reference.

### BACKGROUND OF THE INVENTION

1. Field of the Invention

The present invention relates to a content data reproducing system, a content data reproducing program, and a reproducing apparatus, each of which allows, in a user terminal adapted to be able to read a recording medium storing a content data encrypted with a predetermined encrypted key data, the content data being enabled to be reproduced when a CM data is reproduced.

2. Description of the Related Art

A content data is generally added with a CM (commercial message) data to allow the audience to view and/or listen to the content data at no charge or at a low price, which occurs, for example, in a TV program on the commercial television station. The portable recording medium such as a DVD disc is also attempted to store both the content data such as a film that is a main object to be watched and the CM data to provide a lower distribution price of the recording medium. Also, the online content delivery system has the content data downloaded and stored together with the CM data in the recording medium in a reproducing apparatus.

There are the following problems, however, with the recording medium in which the CM data is recorded. Many of the CMs have the strict delivery deadline set by the contract between the sponsor company and the entertainer, actor/actress or the like that appears in the CMs. If, however, the recording medium storing the CMs with the delivery deadline is distributed, it is very likely that the user views and/or listens to the CMs after the delivery deadline has elapsed, which may cause a trouble between the entertainer or the like and company with respect to the delivery deadline. Also, the company distributing the CM must discard, when it has as a stock the DVD discs or the like storing the CM data with the deadline, the DVD after the deadline has expired.

### SUMMARY OF THE INVENTION

One aspect of this invention provides a content data reproducing system that allows, in a user terminal adapted to be able to read a recording medium storing a content data encrypted with a predetermined encrypted key data, the content data being enabled to be reproduced when a CM data is reproduced, comprising: a CM data transmission unit that transmits the CM data to the user terminal in response to a request from the user terminal; a sensing unit that senses that the reproducing of the CM data has been completed in the user terminal; and a permission unit that permits, when the sensing unit senses that the reproducing of the CM data has been completed, the user terminal to use the encrypted key to decrypt and reproduce the content data.

One aspect of this invention provides a content data reproducing program that allows, in a user terminal adapted to be able to read a recording medium storing a content data encrypted with a predetermined encrypted key data, the content data being enabled to be reproduced after a CM data is reproduced, the content data reproducing program being able to be stored in the user terminal, the content data reproducing program being adapted to be able to perform, in the user terminal: allowing the user terminal to receive the CM data from outside; sensing that the reproducing of the CM data has been completed in the user terminal; and permitting, when it is sensed that the reproducing of the CM data has been completed, the user terminal to use the encrypted key data to decrypt and reproduce the content data.

One aspect of this invention provides a reproducing apparatus adapted to be able to read a recording medium storing a content data encrypted with a predetermined encrypted key data, comprising: a receiving unit that receives a CM data from outside; a reproducing unit that reproduces received the CM data; a sensing unit that senses that the reproducing of the CM data has been completed in the reproducing unit; and a decryption unit that starts, when the sensing unit senses that the reproducing of the CM data has been completed, to encrypt the content data with the encrypted key data.

A different aspect of the present invention provides a reproducing apparatus adapted to be able to read a recording medium storing a content data encrypted with a predetermined encrypted key data, comprising: a decryption unit that decrypts the content data with the encrypted key data; a receiving unit that receives a CM data from outside; a reproducing unit that is able to selectively reproduce received the CM data and decrypted the content data; and a measurement unit that measures a reproducing time of the CM data; the reproducing unit beings adapted to decrypt and reproduce the content data for a time interval corresponding to the measured reproducing time.

A different aspect of the present invention provides a content data reproducing system that allows, in a user terminal adapted to be able to read a recording medium storing a content data encrypted with a predetermined encrypted key data, the content data to be reproduced after a CM data is reproduced, comprising: a CM data transmission unit that transmits the CM data to the user terminal in response to a request from the user terminal; a sensing unit that senses that the reproducing of the CM data has been completed in the user terminal; and a permission unit that permits the user terminal to use the encrypted key to decrypt and reproduce the content data for a time interval corresponding to the reproducing time measured by the measurement unit.

A different aspect of the present invention provides a content data reproducing program that allows, in a user terminal adapted to be able to read a recording medium storing a content data encrypted with a predetermined encrypted key data, the content data to be reproduced after a CM data is reproduced, the content data reproducing program being able to be stored in the user terminal, the content data reproducing program being adapted to be able to perform, in the user terminal, steps comprising the steps of: allowing the user terminal to receive the CM data from outside; measuring a reproducing time of the CM data in the user terminal; and permitting the user terminal to use the encrypted key to decrypt and reproduce the content data for a time interval corresponding to the measured reproducing time.

### BRIEF DESCRIPTION OF THE DRAWINGS

FIG. 1 shows the entire configuration of the content data reproducing system of a first embodiment of the present invention;

FIG. 2 is a flowchart of an example of the operation of the content data reproducing system of the first embodiment in FIG. 1;

FIG. 3 is a data flowchart of the operation of the content data reproducing system in FIG. 1;

FIG. 4 is a flowchart of a different example of the operation of the content data reproducing system in FIG. 1;

FIG. 5 shows the entire configuration of the content data reproducing system of a second embodiment of the present invention;

FIG. 6 is a flowchart of an example of the operation of the content data reproducing system of the second embodiment in FIG. 5;

FIG. 7 shows a configuration example of the CM channel provided in the second embodiment;

FIG. 8 shows a configuration example of the CM channel provided in the second embodiment;

FIG. 9 shows a configuration example of the CM channel provided in the second embodiment;

FIG. 10 shows a modified example of the second embodiment;

FIG. 11 shows a modified example of the second embodiment;

FIG. 12 shows an example of the double encrypted key scheme applied with the present invention; and

FIG. 13 shows a modified example of the embodiment described above.

### DETAILED DESCRIPTION OF THE EMBODIMENTS

Preferred embodiments of the present invention will be described below with reference to the accompanying drawings.

### First Embodiment

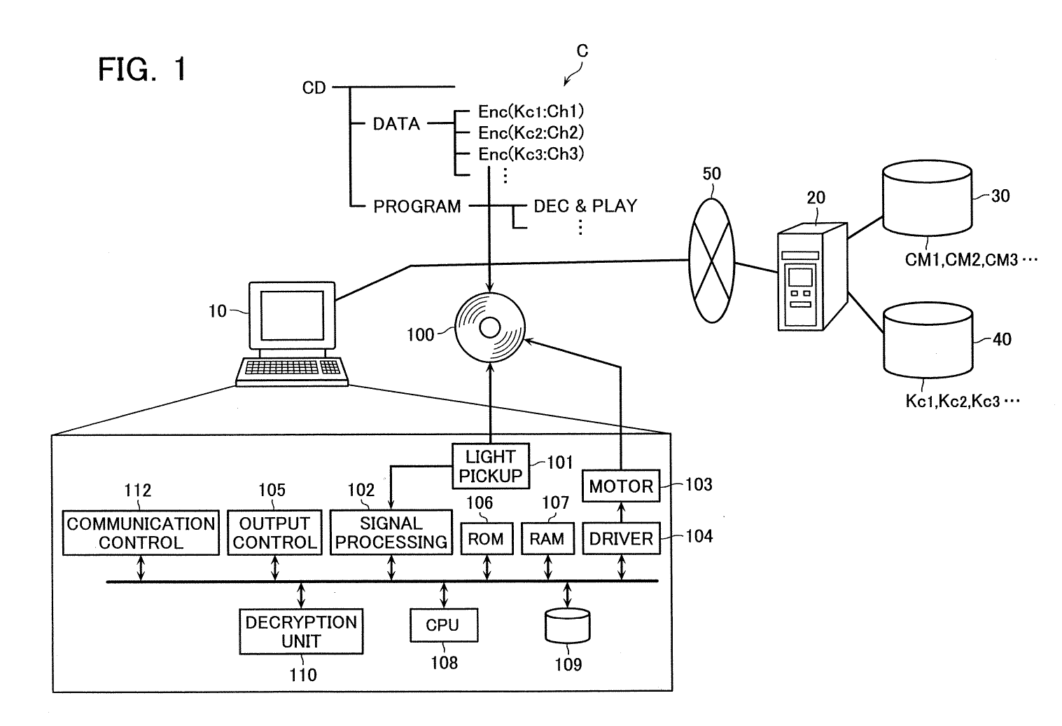

FIG. 1 shows the entire configuration of the content data reproducing system of a first embodiment of the present invention. In this system, the user has a reproducing apparatus (user terminal) 10 such as a personal computer, and reproduces a content data C stored in a recording medium 100 such as a DVD disc. The recording medium 100 is not limited to the DVD disc, and may include a various types of recording media that may store a content data, such as a CD, an MD, or a SD memory card or the like. The recording medium 100 may also be a recording medium incorporated in the reproducing apparatus 10, such as a hard disk drive.

It is supposed in this embodiment that the content data C includes, for example, one film divided into a plurality of chapter data Ch1, Ch2, Ch3 . . . , which correspond to respective scenes (chapters). It is also supposed that each chapter data Chi is encrypted with a different content key data Kci into an encrypted data Enc (Kci: Chi), which is stored in the recording medium.

The reproducing apparatus 10 connects to a server 20 via a network 50 such as the Internet or the like. The server 20 also couples to a CM data-storing unit 30 and to a content key data-storing unit 40. The CM data storing unit 30 is adapted to store CM data CM1, CM2, CM3 . . . that are to be reproduced in the apparatus 10 to be watched by the user in parallel with the content data C. The CM data CMi to be stored is the latest CM data within the delivery deadline. The content key data-storing unit 40 is adapted to store the various content key data Kci that encrypt the content data C in the recording medium 100.

This system allows the content data C stored in the recording medium 100 to be watched on the reproducing apparatus 10 after downloading the content key data Kci and CM data CMi from the server 20 to the reproducing apparatus 10. The system permits the decryption of the encrypted content data Enc (Kci: Chi) with the content key data Kci after the CM data CMi is reproduced, allowing the content data to be reproduced. This series of operations are performed, according to an instruction from a content data reproducing program (DEC & PLAY) recorded in the recording medium 100, by the various components in the reproducing apparatus 10. The data reproducing program is adapted to include the following functions such as downloading various data from the server 20 to the reproducing apparatus 10, sensing that the reproducing of the downloaded CM data has been completed in the reproducing apparatus 10, and permitting the reproducing of the content data after sensing that the reproducing of the CM data has been completed. The data reproducing program may be adapted to be recorded in the recording medium 100 as described above at the same time as the download of the content data, for example, or may be pre-installed in the reproducing apparatus 10 before shipping. The program may also be downloaded from the server 20 online.

The internal configuration of the reproducing apparatus 10 is now described. As an example, the reproducing apparatus 10 includes a light pickup 101 that optically reads the data in the recording medium 100, a signal processing unit 102 that processes the output signal from the light pickup 101, a motor 103 that rotates the recording medium 100, a driver 104 that drives the motor 103, an output control unit 105 that controls the output to the monitor and others, a ROM 106 that stores the boot program and others, a RAM 107 that temporarily stores the CM data or the like, a CPU 108, a hard disk drive (HDD) 109, a decryption unit 110 that decrypts the encrypted content data, and a communication control unit 112 that controls the communication with the outside.

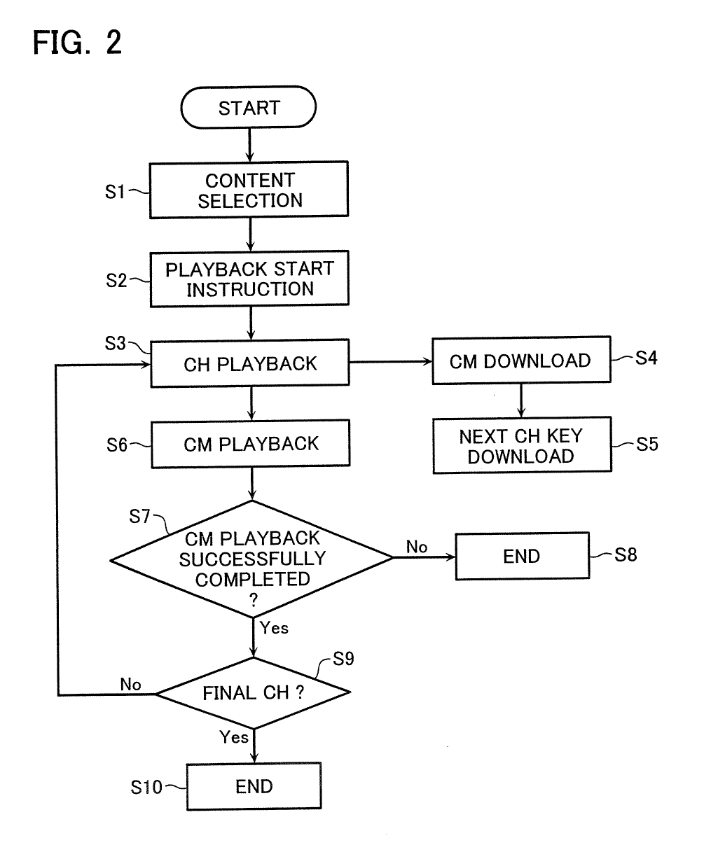

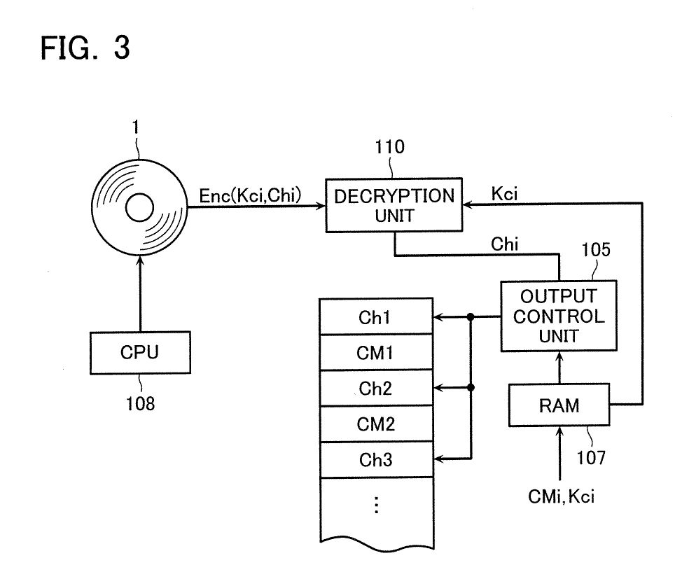

The operation of the content data reproducing system will be described with reference to a flowchart in FIG. 2 and a data flowchart in FIG. 3. The user first inserts the recording medium 100 into a not-shown slot in the reproducing apparatus 10 to start to read from the recording medium 100, and then the content data reproducing program is read from the recording medium 100 and is started up. The program selects the content data C stored in the recording medium 100 (S1), and instructs the reproducing of the content data C (S2), thereby transmitting the content ID of that content data C from the reproducing apparatus 10 to the server 20. The server 20 then specifies, according to the content ID, the content data C. In order to start to reproduce the initial chapter data Ch1 of the content data C, the corresponding content key data Kc1 is downloaded from the server 20 to the reproducing apparatus 10, and is used, as shown in FIG. 3, in the decryption unit 110 to decrypt the encrypted content data Enc (Kc1: Ch1). The decrypted chapter data Ch1 is outputted from the output control unit 105 to a not-shown monitor and a speaker or the like, starting reproducing of the chapter data Ch1 (S3).

In parallel, the reproducing apparatus 10 starts to download the CM data from the server 20 (S4). What is downloaded is the CM data CM1 to be reproduced after the reproducing of the chapter data Ch1 has been completed. The CM data to be reproduced is selected appropriately based on the attribute of the selected content data, or the time zone in which the reproducing is requested or the like. In order to decrypt the next chapter data Ch2, the download of the content key data Kc2 is then started (S5). The downloaded CM data CM1 and content key data Kc2 are temporarily stored in the RAM 107. Thus, the CM data is downloaded in parallel with the reproducing of the chapter data. Therefore, if the system does not use a broadband environment, the CM data may be downloaded sufficiently long before the reproducing of the chapter data has been completed.

After the reproducing of the chapter Ch1 is complete, the CM data CM1 temporarily stored in the RAM 107 started to be reproduced (S6). The CPU 108 senses, according to the content data reproducing program, whether the CM data is completely reproduced (S7). The CPU 108 senses it such as by monitoring, during the CM data CM1's broadcast time (for example 15 seconds), illegal operations such as operations for interrupting the normal reproducing of the CM data (reproducing stop, fast forward or the like). When the CPU 108 senses illegal operations by which the reproducing of the CM data CM1 is not successfully completed and is aborted or the like, the reproducing of the following content data C is cancelled (S8). Instead of the cancellation, the reproducing apparatus 10 may display on its monitor that the CM data should be reproduced completely or otherwise the following content data C may not be reproduced, thus prompting the user to view and/or hear the CM data again.

When the CPU 108 senses that the CM data CM1 is successfully reproduced, the CPU 108 then determines whether the CM data CM1 is the final chapter (S9). If the determination is YES, the reproducing is ended (S10), and if it is NO, then control returns to S3 where the following chapter data Ch2 is reproduced. In this way, the procedure from S3 to S9 continues until the final chapter completes its reproducing, thus alternately reproducing the chapter data Chi and CM data CMi as shown in FIG. 3. Note that every time the CM data CMi completes its reproducing, the reproducing apparatus 10 transmits to the server 20 the CM number (ID) of that CM data CMi. The server 20 may collect the CM number data to provide data on what type of content data is reproduced at what time zone and what type of CM is watched during that time zone. The data may be used to distribute the content charge to the content provider, or to charge the sponsor company for the CM fee or the like.

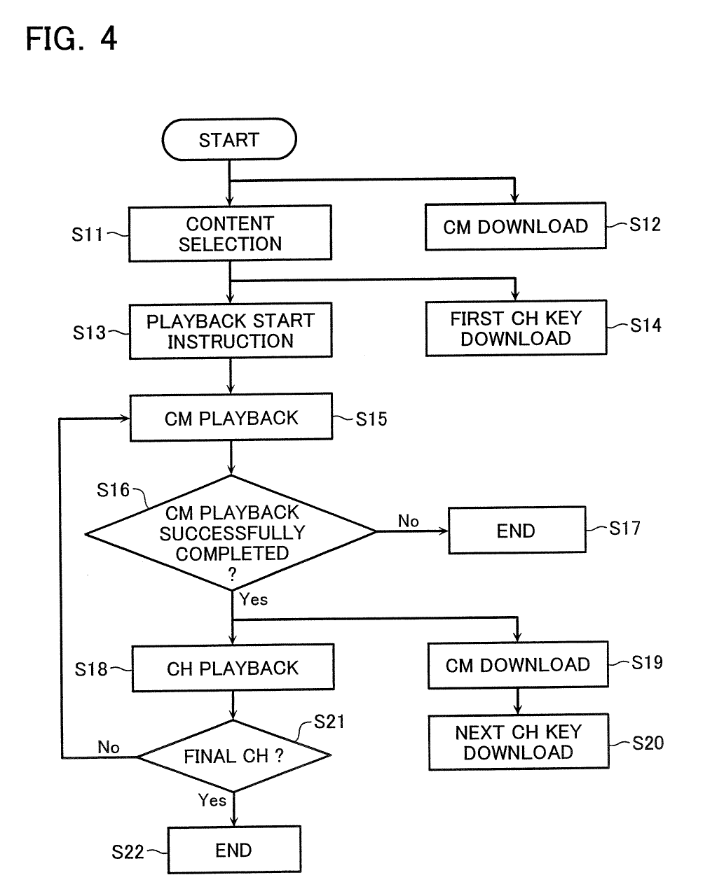

Note that although FIGS. 2 and 3 show examples where the chapter data Chi is first reproduced and then the CM data CMi is reproduced, the procedure may be converted, as shown in FIG. 4, by reproducing the CM data CMi first and then the chapter data Chi.

Thus, the present embodiment allows, in a form where the content data recorded in the recording medium is watched along with the CM data, the reproducing apparatus 10 to always receive from the server 20 the latest CM data, which is then watched by the user. In this way, when the latest CMs may be watched along with the content data recorded in the recording medium, the content containing a large amount of data may be distributed through a variety of routes (disc distribution, pre-downloading, and P2P file exchange and the like), thus the server may bear less load, resulting that the sponsor may bear less burden to provide the content.

### Second Embodiment

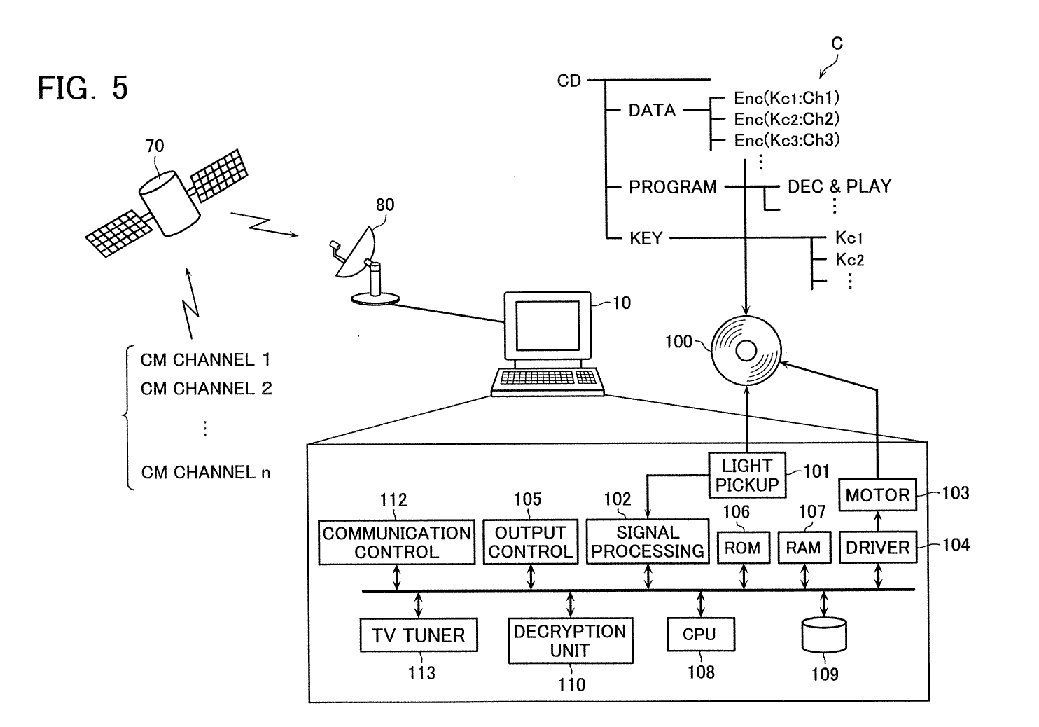

FIG. 5 shows the entire configuration of the content data reproducing system of a second embodiment of the present invention. This embodiment differs from the first embodiment in that the CM data is received not via the Internet but via a broadcast network such as the satellite broadcasting. Specifically, the CM data is broadcasted through CM channels 1, 2, . . . , n that are provided by a broadcast station or a server under contract with the broadcast station via a broadcast satellite 70. Each reproducing apparatus 10 connects to, for example, an antenna 80 for receiving the broadcast to receive the CM data. The received CM data is acquired by a TV tuner 113 that is located in the reproducing apparatus 10 or is externally connected thereto, and then temporarily stored in the RAM 107 as in the first embodiment. Note that it is supposed in this embodiment that the content key data Kci to decrypt the encrypted content data Enc (Kci: Ch1) is stored in the recording medium 100 at the same time as when the content data C is acquired. The content key data may also be received, however, through the CM channel via the broadcast network along with the CM data.

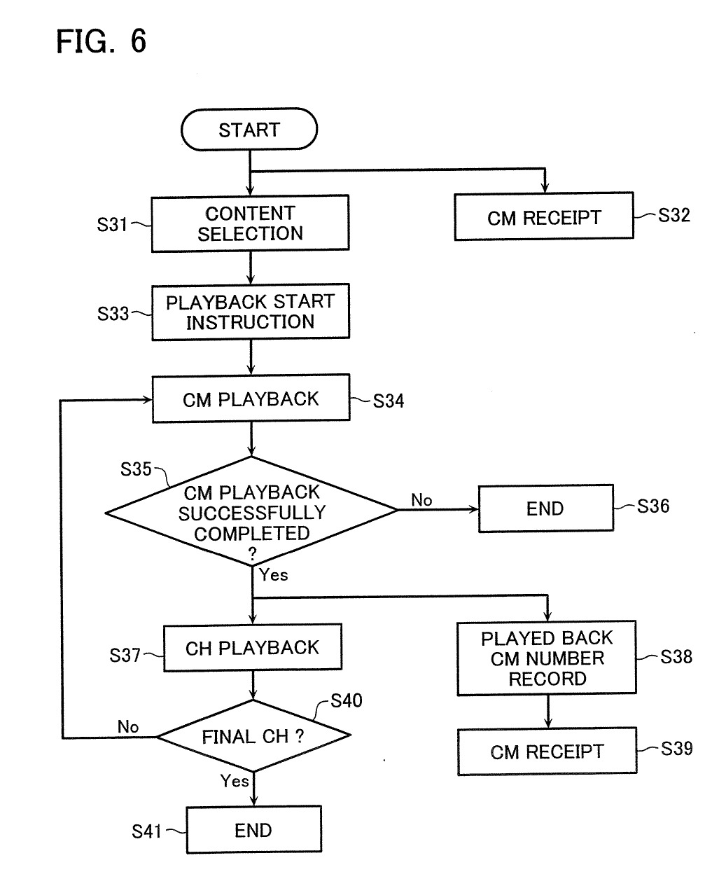

FIG. 6 is a flowchart of the reproducing procedure of the content data C of the present embodiment. Except that the CM data being downloaded via the Internet is replaced by the CM data being received via the broadcast network (S32, S39), this embodiment uses much the same procedure as the first embodiment. Its detailed description is thus omitted here for simplicity. Also, the received CM data is temporarily stored in the RAM 107 as in the first embodiment. This embodiment differs from the first embodiment, however, in that when the CM data is successfully reproduced, the CM number of the reproduced CM data is recorded as the CM reproducing log in the HDD 109 or the like (S38). The CM number data of the reproduced CM data is used to select the CM that is subsequently received and reproduced in the reproducing apparatus 10, thereby avoiding a situation where the same CM is reproduced many times or the like. The CM reproducing log may also be provided in any other suitable way such as by providing it, when the user accesses a not-shown content delivery server to acquire a different content data, to the server. The broadcast station or the like providing the CM may thus know what type of user reproduces what type of content data at what time with which CM. This knowledge may be used to distribute the content charge to each content-providing company, and to charge the sponsor company for the CM fee, as well as to edit the CM channel described above or the like. Note that although FIG. 6 shows an example where the CM data CMi is first reproduced and then the chapter data Chi is reproduced, the procedure may be converted by reproducing the chapter data Chi first and then the CM data CMi.

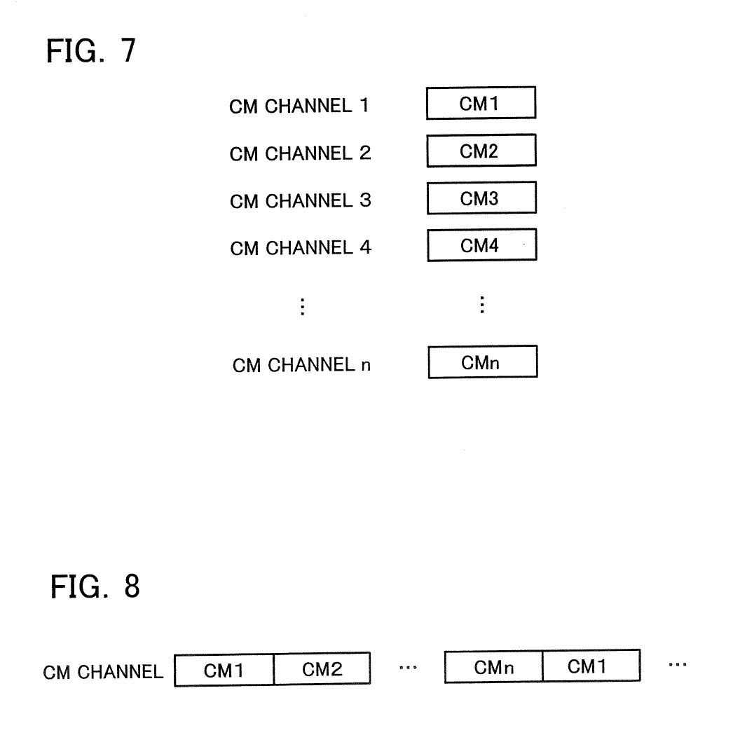

FIGS. 7 to 9 show examples of the configuration scheme of the CM channel provided by the broadcast station or server or the like. FIG. 7 is an example where a large number of channels are configured in such a way that the CM channel and content data correspond on a one-on-one basis. Consider, for example, that there are an action-film content data C1, a romantic film content data C2, and a children's animated film C3 and the like. In this case, the CM channel 1 provided for the content data C1 includes a large number of CMs targeting young men who are the primary audience of the action films. Likewise, the CM channel 2 includes a large number of CMs targeting young women, the CM channel 3 includes a large number of CMs targeting children. In this case, the TV tuner 113 in the reproducing apparatus 10 is controlled by the content data reproducing program to be tuned to receive the CM channel corresponding to the selected content data.

FIG. 8 is an example where a single CM channel is used for broadcast. In this example, the single CM channel repeatedly broadcasts n types of CM s from the number one to n. Regardless of the types of the content data to be reproduced, the same CM data are received and reproduced in the same time zone by a large number of reproducing apparatuses 10. Even in this case, broadcasting different CM data depending on the time zone may allow the CMs corresponding to the different types of audience to be received and reproduced.

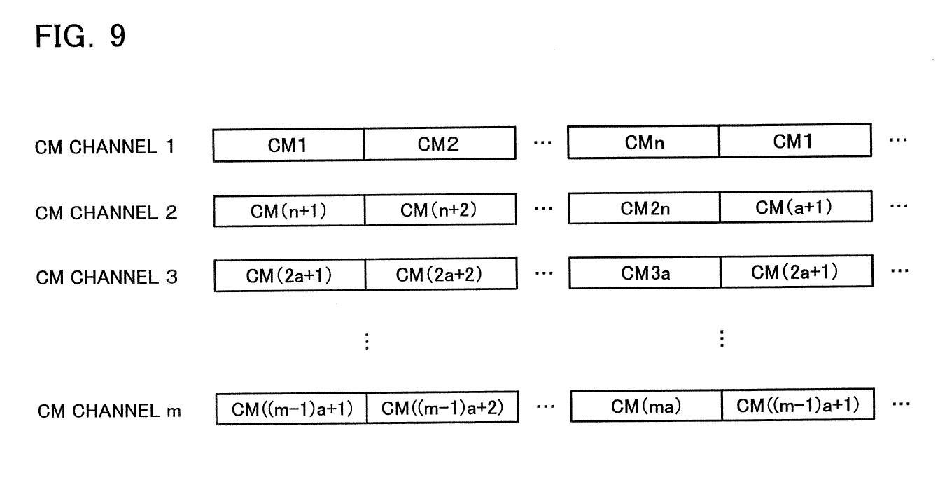

FIG. 9 shows an example where there is not a number of CM channels corresponding to the content data on a one-on-one basis, but is a plurality of CM channels less than the number of types of content data, and the CM channels are classified into different categories, for example. The CM channels are classified in such a way that, for example, the CM channel 1 mainly provides the CMs for young men, the CM channel 2 mainly provides the CMs for young women, and the CM channel 3 mainly provides the CMs for middle-age people.

After the reproducing apparatus 10 selects the content data to be reproduced, the attribute (such as the category) and time zone of watching and the like of that content data are used as a basis to sequentially select the CM channels while one content data C is reproduced and reproduce the CM channels along with the content data C in the reproducing apparatus 10. When, for example, a content data for a family that may be watched by any age is selected in the so-called prime time from 7 pm to 9 pm, each CM channel i is selected appropriately to allow a various types of CMs to be watched. Even for the content data for a family having the same attribute, if the content data is watched in a time zone in the middle of the night, the CM channels are preferably selected in such a way that the CMs for young people are mostly broadcasted.

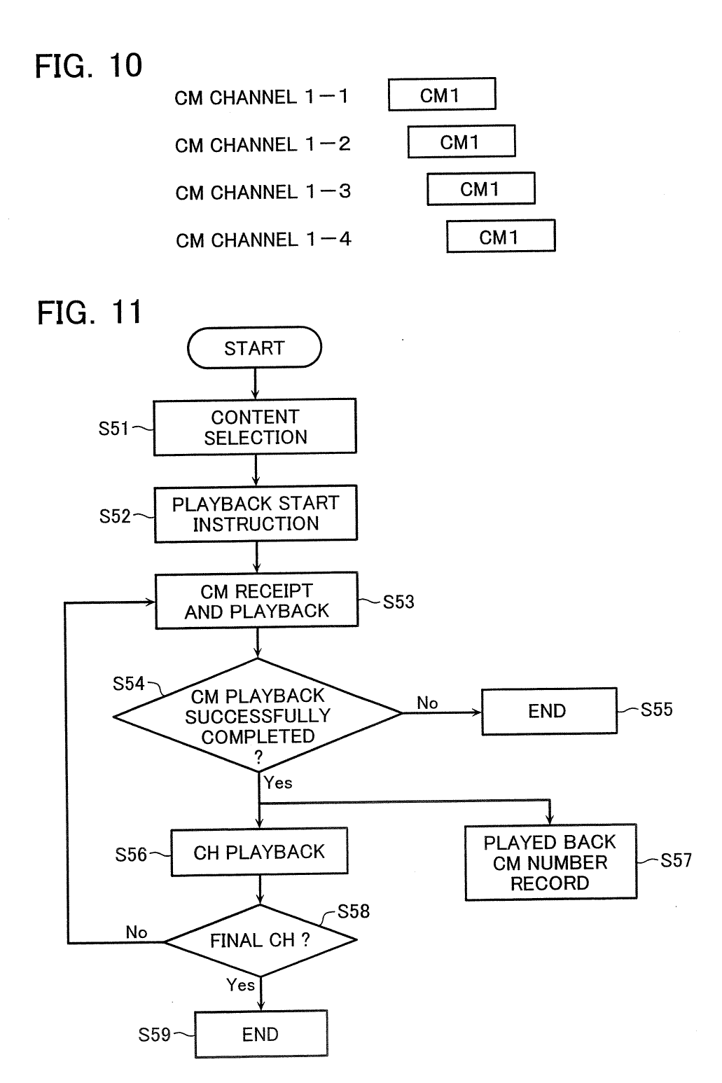

FIGS. 10 and 11 show modified examples of the second embodiment. The modified example may have the same system configuration as the second embodiment (FIG. 5). The modified example, however, differs from the second embodiment in that in the modified example, the CM data is not temporarily stored in the HDD or the like, and the CM data received by the antenna is directly reproduced as raw data without a time lag, in contrast to the second embodiment where the received CM data is temporarily stored in the HDD or the like. When the CM data is reproduced as raw data as described above, it should be prevented that the CM in 15-second unit is broadcasted with the initial or final portion thereof being cut off. In this modified example, therefore, as shown in FIG. 10, the CMs having the same content are broadcasted from the broadcast station at the same time through the plural CM channels 1-1, 1-2, 1-3, 1-4 . . . in such a way that the CMs are given an offset in time from each other by a few seconds. The TV tuner 10 is tuned, depending on the broadcast schedule data of each CM channel 1-1, 1-2, 1-3, 1-4 . . . , to the CM channel that has the start timing of the CM closest to the timing of the reproducing start instruction (S52 in FIG. 11). It is thus possible to reproduce the CM data without the initial or final portion thereof being cut off.

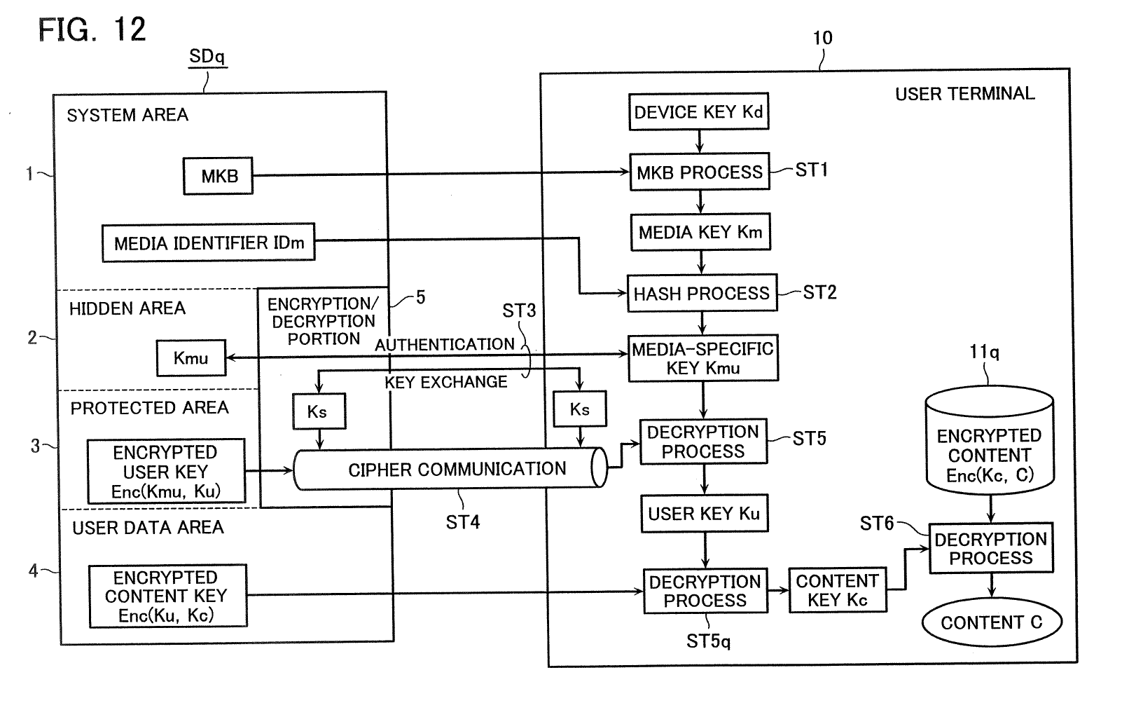

Thus, although the invention has been described with respect to particular embodiments thereof, it is not limited to those embodiments. Various modifications, substitutions, and additions and the like may be made without departing from the spirit of the present invention. Although, for example, the embodiments described above use the single-key encryption scheme with the content key data Kci alone, the invention is not limited thereto, and the encryption double-key scheme used in the MQbic (registered trademark) may also be applied. FIG. 12 is a schematic diagram of the configuration of the SD card and user terminal (reproducing apparatus) corresponding to the encryption double-key scheme used in the MQbic. The SD card SDq is an example of the secure storage medium that securely stores the data. The SD memory card SDq includes a system area 1, a hidden area 2, a protected area 3, a user data area 4, and an encryption/decryption unit 5. Each of the areas 1 to 4 stores data.

Specifically, in the SD memory card SDq, the system area 1 stores a key management information medium key block (MKB) and a media identifier IDm, the hidden area 2 stores a media-specific key data Kmu, the protected area 3 stores an encrypted user key data Enc(Kmu:Ku), and the user data area 4 stores a content key data Enc(Ku:Kc). The user key Ku is an encryption/decryption key for the content key Kc, and is used in common for a plurality of encrypted content keys Enc (Ku: Kc1), Enc (Ku: Kc2) . . . . The subscript q of the SD card SDq indicates that the SD card SDq corresponds to the MQbic (registered trademark).

The system area 1 is read-only and accessible from outside of the SD memory card. The hidden area 2 is also read-only and is referred by the SD memory card itself and is never accessible from outside of the SD memory card. The protected area 3 may be read/written from outside of the SD memory card if the user is successfully authenticated. The user data area 4 may be freely read/written from outside of the SD memory card. The encryption/decryption unit 5 is adapted to perform the authentication, key exchange, and cipher communication between the protected area 3 and outside of the SD memory card, and has a function of encryption/decryption.

For such a SD card SDq, the user terminal 10 for reproducing operates logically as follows. The user terminal 10 performs, using a preset device key Kd, an MKB process (ST1) on the key management information MKB read from the system area 1 of the SD card SDq, thereby obtaining a media key Km. The user terminal 10 then performs a hash process (ST2) both on the media key Km and on the media identifier IDm that is read from the system area 1 of the SD card SDq, thereby obtaining a media-specific key Kmu.

The user terminal 10q then performs, according to the media-specific key, the authentication and key exchange (AKE) (ST3) with the encryption/decryption unit 5 of the SD card SDq, thereby sharing the session key Ks with the SD card SDq. Note that the authentication and key exchange at step 3 are successful thereby sharing the session key Ks when the media-specific key Kmu in the hidden area 2 that is referred to by the encryption/decryption unit 5 coincides with the media-specific key Kmu generated in the handheld device 10a.

The user terminal 10 then reads, via the cipher communication using the session key Ks, the encrypted user key Enc (Kmu: Ku) from the protected area 3 (ST4), and decrypts (ST5) the encrypted user key Enc (Kmu: Ku) with the media-specific key Kmu, thereby obtaining the user key Ku.

Finally, the user terminal 10 reads the encrypted content key Enc(Ku:Kc) from the user data area 4 of the SD card SDq, and then decrypts (ST5q) the encrypted content key Enc(Ku:Kc) with the user key Ku, thereby obtaining the content key Kc. Finally, the user terminal 10a reads the encrypted content Enc (Kc:C) from the memory 11q, and then decrypts (ST6) the encrypted content Enc (Kc:C) with the content key Kc and reproduces the resulting content C. Note that although in the above embodiment the encrypted content is stored in the memory 11q in the user terminal 10, the encrypted content may also be stored in an external storage medium. The present invention may be applied by using such a user terminal as the reproducing apparatus, and storing in the user terminal 10 the content data reproducing program that permits the content data C to be decrypted with the content key data Kc after the reproducing of the CM data is complete.

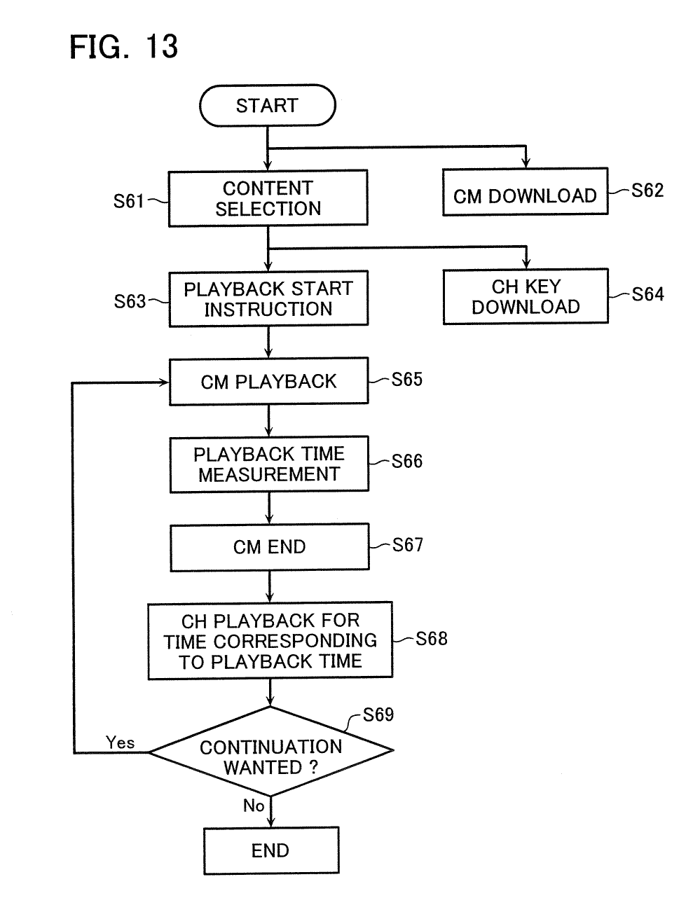

Although in the embodiments described above the content data is permitted to be reproduced after the reproducing of the downloaded CM is complete, alternatively or additionally, the reproducing time of the downloaded CM may be measured and the content data may be permitted to be decrypted and reproduced for a time interval corresponding to the measured reproducing time. FIG. 13 shows a flowchart of the system that performs the procedure as described above. As in the embodiments described above, after the content selection, CM download, reproducing instruction, and key download are performed (S61-64), the CM data starts to be reproduced (S65) and the reproducing time starts to be measured. The reproducing time may be measured according to the instruction from the content data reproducing program and based on the clock signal of the CPU 108 and the like. When the CM data completes its reproducing due to the user's reproducing stop operation or other reasons (S68), the content data C (i.e., the chapter data) is reproduced for a time interval corresponding to the CM reproducing time before the completion of the CM data. After the content data is reproduced for the corresponding time interval, the reproducing apparatus 10 displays on its monitor a question asking whether the user wants to continue the reproducing. If the user selects the continuation of the reproducing, then the control returns to S65 where the CM starts to be reproduced again.

What is claimed is:

1. A content data reproducing system that allows, in a user terminal adapted to be able to read a recording medium storing a content data encrypted with a predetermined encrypted key data, said content data being enabled to be reproduced when a CM data is reproduced, comprising:
a CM data transmission unit that transmits the CM data to said user terminal in response to a request from said user terminal;
a sensing unit that senses that the reproducing of said CM data has been completed in said user terminal; and
a permission unit that permits, when said sensing unit senses that the reproducing of said CM data has been completed, said user terminal to use said encrypted key to decrypt and reproduce said content data.

2. The content data reproducing system according to claim 1, wherein
said content data is divided into a plurality of chapters with each chapter encrypted with a different encrypted key data and stored in said recording medium,
said CM data is reproduced during an interval between the periods when said plurality of chapters are reproduced, and
said permission unit permits, when said sensing unit senses that the reproducing of said CM data has been completed, a following chapter to be decrypted and reproduced.

3. The content data reproducing system according to claim 1, wherein said CM data transmission unit uses an attribute of said content data to be reproduced in said user terminal as a basis to select the CM data to be provided and transmits the CM data to said user terminal.

4. The content data reproducing system according to claim 1, wherein said CM data transmission unit uses an attribute and time of said content data to be reproduced in said user terminal as a basis to select said CM data and transmits the CM data to said user terminal.

5. A reproducing apparatus adapted to be able to read a recording medium storing a content data encrypted with a predetermined encrypted key data, comprising:
a receiving unit that receives a CM data from outside;
a reproducing unit that reproduces said received CM data;
a sensing unit that senses that the reproducing of said CM data has been completed in said reproducing unit; and
a decryption unit that starts, when said sensing unit senses that the reproducing of said CM data has been completed, to decrypt said content data with said encrypted key data.

6. The reproducing apparatus according to claim 5, wherein
said content data is divided into a plurality of chapters with each chapter encrypted with a different encrypted key data and stored in said recording medium,
said reproducing unit is adapted to reproduce said CM data during an interval between the periods when said plurality of chapters are reproduced, and
said decryption unit starts, when said sensing unit senses that the reproducing of said CM data has been completed, to decrypt a following chapter.

7. A content data reproducing program that allows, in a user terminal adapted to be able to read a recording medium storing a content data encrypted with a predetermined encrypted key data, said content data being enabled to be reproduced after a CM data is reproduced, said content data reproducing program being able to be stored in said user terminal,
said content data reproducing program being adapted to be able to, in said user terminal, perform steps comprising:
allowing said user terminal to receive the CM data from outside;
sensing that the reproducing of said CM data has been completed in said user terminal; and
permitting, when it is sensed that the reproducing of said CM data has been completed, said user terminal to use said encrypted key data to decrypt and reproduce said content data.

8. A reproducing apparatus adapted to be able to read a recording medium storing a content data encrypted with a predetermined encrypted key data, comprising:
a decryption unit that decrypts said content data with said encrypted key data;
a receiving unit that receives a CM data from outside;
a reproducing unit that is able to selectively reproduce said received CM data and said decrypted content data; and
a measurement unit that measures a reproducing time of said CM data;
said reproducing unit being adapted to decrypt and reproduce said content data for a time interval corresponding to the measured reproducing time.

9. A content data reproducing system that allows, in a user terminal adapted to be able to read a recording medium storing a content data encrypted with a predetermined encrypted key data, said content data being enabled to be reproduced after a CM data is reproduced, comprising:
a CM data transmission unit that transmits the CM data to said user terminal in response to a request from said user terminal;
a measurement unit that measures a reproducing time of said CM data in said user terminal; and
a permission unit that permits said user terminal to use said encrypted key to decrypt and reproduce said content data for a time interval corresponding to the reproducing time measured by said measurement unit.

10. A content data reproducing program that allows, in a user terminal adapted to be able to read a recording medium storing a content data encrypted with a predetermined encrypted key data, said content data being enabled to be reproduced after a CM data is reproduced, said content data reproducing program being able to be stored in said user terminal,
said content data reproducing program being adapted to be able to perform, in said user terminal,:
allowing said user terminal to receive the CM data from outside;
measuring a reproducing time of said CM data in said user terminal; and
permitting said user terminal to use said encrypted key to decrypt and reproduce said content data for a time interval corresponding to the measured reproducing time.
